(19) United States
(12) Patent Application Publication
(10) Pub. No.: US 2013/0300281 A1
(43) Pub. Date: Nov. 14, 2013

(54) COPOLYMERS FOR LUMINESCENCE ENHANCEMENT IN REFLECTIVE DISPLAY APPLICATIONS

(71) Applicants: Zhang-Lin Zhou, Palo Alto, CA (US); Gary Gibson, Palo Alto, CA (US); Lihua Zhao, Sunnyvale, CA (US)

(72) Inventors: Zhang-Lin Zhou, Palo Alto, CA (US); Gary Gibson, Palo Alto, CA (US); Lihua Zhao, Sunnyvale, CA (US)

(21) Appl. No.: 13/980,119

(22) PCT Filed: Jan. 21, 2011
(86) PCT No.: PCT/US11/22130

§ 371 Date: Jul. 17, 2013

(51) Int. Cl. C09K 11/06; H05B 33/00

(52) U.S. Cl. CPC C09K 11/06; H05B 33/00
USPC 313/498; 528/391; 528/377; 252/301.35

(57) ABSTRACT

Copolymers for luminescent enhancement in reflective display applications comprise a functionalized fluorene moiety, including a functional group selected from water-soluble functional groups and/or alcohol-soluble functional groups, and a heterocyclic ring moiety selected from the group consisting of substituted carbazole derivatives, substituted benzothiadiazole derivatives, and substituted phenothiazine derivatives, wherein the respective substituted derivatives include a functional group selected from water-soluble functional groups and/or alcohol-soluble functional groups. Composite materials comprising the copolymers and photoluminescent dyes are also provided, as is a luminescence-based sub-pixel (100).

### BACKGROUND

A reflective display is a non-emissive device in which ambient light is used for viewing the displayed information. Rather than modulating light from an internal source, desired portions of the incident ambient light spectrum are reflected from the display back to a viewer. Electronic paper (e-paper) technologies have evolved to provide single layer monochromatic displays that control the reflection of ambient light. Luminescence-based materials provide alternative, more efficient pathways for utilizing ambient light in reflective displays, thus making bright, full color reflective displays possible.

### BRIEF DESCRIPTION OF THE DRAWINGS

FIG. 1 is a cross-sectional view of a luminescence-based sub-pixel in accordance with an example of the present disclosure.

FIG. 2 is a cross-sectional view of a luminescence-based pixel in accordance with an example of the present disclosure.

FIG. 3 is a flow chart setting forth a method in accordance with an example of the present disclosure.

### DETAILED DESCRIPTION

It is to be understood that this disclosure is not limited to the particular process steps and materials disclosed herein because such process steps and materials may vary somewhat. It is also to be understood that the terminology used herein is used for the purpose of describing particular examples only. The terms are not intended to be limiting because the scope of the present disclosure is intended to be limited only by the appended claims and equivalents thereof.

It is noted that, as used in this specification and the appended claims, the singular forms “a,” “an,” and “the” include plural referents unless the context clearly dictates otherwise.

As used herein, “alkyl” refers to a branched, unbranched, or cyclic saturated hydrocarbon group, which typically, although not necessarily, includes from 1 to 50 carbon atoms, or 1 to 30 carbon atoms, or 1 to 6 carbons, for example. Alkyls include, but are not limited to, methyl, ethyl, n-propyl, isopropyl, n-butyl, isobutyl, t-butyl, octyl, and decyl, for example, as well as cycloalkyl groups such as cyclopentyl, and cyclohexyl, for example.

As used herein, “aryl” refers to a group including a single aromatic ring or multiple aromatic rings that are fused together, directly linked, or indirectly linked (such that the different aromatic rings are bound to a common group such as a methylene or ethylene moiety). Aryl groups described herein may include, but are not limited to, from 5 to about 50 carbon atoms, or 5 to about 40 carbon atoms, or 5 to 30 carbon atoms or more. Aryl groups include, for example, phenyl, naphthyl, anthryl, phenanthryl, biphenyl, diphenylether, diphenylamine, and benzophenone. The term “substituted aryl” refers to an aryl group comprising one or more substituent groups. The term “heteroaryl” refers to an aryl group in which at least one carbon atom is replaced with a heteroatom. If not otherwise indicated, the term “aryl” includes unsubstituted aryl, substituted aryl, and heteroaryl.

As used herein, “substituted” means that a hydrogen atom of a compound or moiety is replaced by another atom such as a carbon atom or a heteroatom, which is part of a group referred to as a substituent. Substituents include, for example, alkyl, alkoxy, aryl, aryloxy, alkenyl, alkenoxy, alkynyl, alkynoxy, thioalkyl, thioalkenyl, thioalkynyl, and thioaryl.

The terms “halo” and “halogen” refer to a fluoro, chloro, bromo, or iodo substituent.

As used herein, “alcohol” means a lower alkyl chain alcohol, such as methanol, ethanol, and iso-propanol, as well as their perfluorinated analogs.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Most currently used red-emitting conjugated polymers are based on MEH-PPV (poly[2-methoxy-5-(2′-ethylhexyloxy)-p-phenylene vinylene]) or CN-PPV (cyano-polyphenyl vinylene) and their analogs, but these polymer types may have inadequate photoluminescence emission efficiencies and therefore may not be suitable for use by themselves in enhancing the brightness of reflective displays. There are also red-emitting small molecules, but their absorption tends to be inadequate to absorb most of the desired ambient spectrum within a reasonably thin film unless their concentration is very high. However, with the high concentration, they suffer from concentration quenching, making it difficult to use them for both absorption and emission in reflective display applications. To date, there are no existing material combinations that provide the desired combination of thin-film absorption and emission at wavelengths required for boosting the brightness of reflective displays.

Luminescent enhancement has the potential to significantly boost the brightness of reflective displays. However, this requires materials that absorb over a broad spectrum of wavelengths below the desired emission wavelength and efficiently emit the absorbed energy at the desired wavelength. A promising method for accomplishing this is to disperse highly efficient luminescent dyes into broadly absorbing polymers that can transfer the energy they absorb to the dyes through processes such as Förster exchange. Unfortunately, many of the dyes that would be useful for this purpose are fairly polar so that they are not so compatible with many polymers that are of interest, which tend to be less polar. Methods are disclosed herein for creating polymers that are more compatible with dyes and solvents useful for creating broadly absorptive, highly efficient luminescent composites for reflective display applications. It should be noted that the increased compatibility of polymer and dye results in better dispersion of the dye molecules and fewer dimers, trimers, or larger aggregates of dye molecules that lead to concentration quenching.

In accordance with various aspects of the teachings herein, novel water-soluble and/or alcohol-soluble red or green emissive polymers for luminescence enhancement in reflective display applications are provided. These types of red or green emissive polymers are copolymers based on substituted fluorene and heterocyclic ring systems that bear water-soluble and/or alcohol-soluble functional groups. These emissive copolymers can be well-mixed with relatively polar commercially available highly-efficient luminescent dyes such as sulforhodamine 640, some BODIPY (4,4-difluoro-4-bora-3a,4a-diaza-s-indacene) dyes, and Alexa Fluor® dyes (Alexa Fluor is a trademark for fluorescent dyes of Invitrogen Corp., Carlsbad, Calif.) to form a uniform film. With the synthetic variations, the ratio of fluorene and heterocyclic ring unit can be tuned and the emissive wavelength and quantum efficiency can be adjusted over the ranges of 620 nm to 450 nm and 5 to 95%, respectively.

Green emissive polymers would also be useful in cases where they are combined with dyes that absorb in the green. If, for example, one uses a dye that luminesces in the red but absorbs strongly in the green, then the polymer host-absorber can emit in the green and transfer its collected energy to the red-emitting dye via a process such as Förster exchange.

When mixed with photoluminescent dyes, the copolymers disclosed herein may act as radiation absorbers. A radiation absorber can absorb energy in the form of electromagnetic radiation and transfer the energy to the dye via a resonant energy transfer mechanism; e.g., via Förster exchange. In one example, the electromagnetic radiation can be ultraviolet (UV), infrared (IR), and/or visible electromagnetic radiation. The terms “luminescent” and “fluorescent” and their cognates are used interchangeably herein, but it should be noted that the effect described above, namely, the emitted light having a longer wavelength, and therefore lower energy, than the absorbed radiation, is most closely associated with fluorescence.

While the description herein is presented in terms of red emissive copolymers, the same considerations may apply for providing green and even blue emissive copolymers. For red emissive copolymers, the emission energy is the lowest for the three colors, and it is possible to convert all shorter wavelengths to red. In most ambient environments, less light energy is available for conversion to green or blue than to red. This is because there are no efficient processes for converting longer wavelengths to shorter wavelengths. Thus, a blue- and/or UV-emitting composite can only make efficient use of shorter wavelength blue and ultraviolet ambient light.

Copolymer 1 illustrates an example of these types of new water- and/or alcohol-soluble copolymers, based on substituted fluorene (left portion) and substituted carbazole derivatives (right portion):

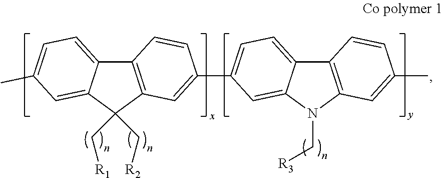

wherein:

the substituents R₁, R₂, and R₃ are each independently selected from one or more groups of COOZ, SO₃Z, PO₃Z, NR₃⁺Y⁻, and (CH₂CH₂O)ₘCH₃, where Z is independently selected from hydrogen, a monovalent metal ion, and NR₄⁺; R is independently selected from hydrogen, an alkyl group and an aryl group; Y⁻ is an anion selected from one of a halogen, sulfate, sulfonate or other negative species, such as nitrate, phosphate or borate (e.g., tetrafluoroborate, tetraphenylborate, etc.); m is an integer ranging from 1 to 500; x and y are integers independently ranging from 1 to 5,000; and n is an integer ranging from 1 to 30. The substituents R₁ to R₃ confer water and/or alcohol solubility to the copolymer.

Copolymer 1 may have one or more additional substituents on any of the phenyl rings, as shown below:

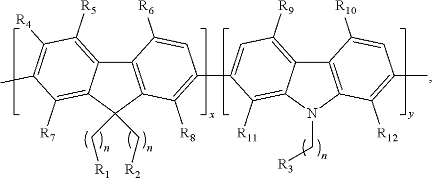

where R₄ to R₁₂ may either be hydrogen (as shown above for copolymer 1) or any of the groups listed for R₁ to R₃.

Copolymer 2 illustrates another example of these types of new water- and/or alcohol-soluble copolymers based on functionalized fluorene (left portion) and substituted benzothiadiazole derivatives (right portion):

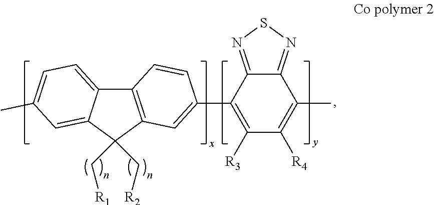

wherein:

the substituents R₁, R₂, R₃, and R₄ are each independently selected from one or more groups of COOZ, SO₃Z, PO₃Z, NR₃⁺Y⁻, and (CH₂CH₂O)ₘCH₃, where Z is independently selected from hydrogen, a monovalent metal ion, and NR₄⁺; R is independently selected from hydrogen, an alkyl group and an aryl group; Y⁻ is an anion selected from one of a halogen, sulfate, sulfonate or other negative species, such as nitrate, phosphate or borate (e.g., tetrafluoroborate, tetraphenylborate, etc.); m is an integer ranging from 1 to 500; x and y are integers independently ranging from 1 to 5,000; and n is an integer ranging from 1 to 30. The substituents R₁ to R₄ confer water and/or alcohol solubility to the copolymer.

Copolymer 2 may have one or more additional substituents on any of the phenyl rings, as shown below:

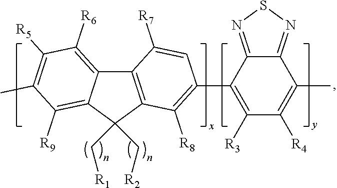

where R₅ to R₉ may either be hydrogen (as shown above for copolymer 2) or any of the groups listed for R₁ to R₄.

Copolymer 3 gives another example of these types of new water- and/or alcohol-soluble copolymers based on functionalized fluorene (left portion) and substituted phenothiazine derivatives (right portion):

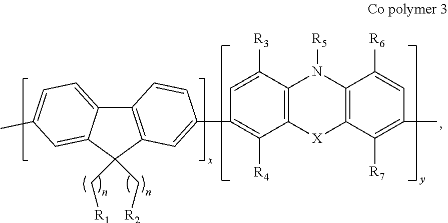

wherein,

the substituents R₁, R₂, R₃, R₄, R₅, R₆, and R₇ are each independently selected from one or more water soluble groups of COOZ, SO₃Z, PO₃Z, NR₃⁺Y⁻, and (CH₂CH₂O)ₘCH₃, where Z is independently selected from hydrogen, a monovalent metal ion, and NR₄⁺; R is independently selected from hydrogen, an alkyl group and an aryl group; Y⁻ is an anion selected from one of a halogen, sulfate, sulfonate or other negative species, such as nitrate, phosphate or borate (e.g., tetrafluoroborate, tetraphenylborate, etc.); X is oxygen or sulfur; m is an integer ranging from 1 to 500; x and y are integers independently ranging from 1 to 5,000; and n is an integer ranging from 1 to 30. The substituents R₁ to R₇ confer water and/or alcohol solubility to the copolymer.

Copolymer 3 may have one or more additional substituents on any of the phenyl rings, as shown below:

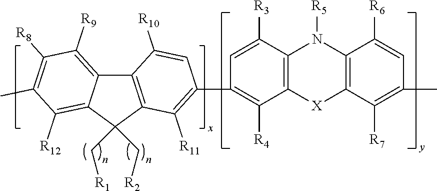

where R₈ to R₁₂ may either be hydrogen (as shown above for copolymer 3) or any of the groups listed for R₁ to R₇.

As noted above, the ratio of fluorene and heterocyclic ring unit (specifically, the values of x and y) can be tuned to permit adjustment to the desired emissive wavelength and quantum efficiency.

In some examples, these copolymers may be useful for luminescence enhancement in reflective display applications where they may be “compatible” with high efficiency luminescent dyes such as sulforhodamine 640. This means that the copolymers may have the following properties:
The copolymers may be soluble in water and/or alcohol. By “soluble” is meant that the solubility of the copolymer in water and/or alcohol may be at least 5 mg/ml.
The emission wavelengths of the copolymer may overlap with the absorption spectrum of the dye (for example, the absorption peak is at ˜585 nm for sulforhodamine 640). The overlap between the maximum emission wavelength and the maximum absorption wavelength may be up to 50 nm.
The dye may be dispersed in the copolymer at a concentration sufficient to collect all of the energy absorbed by the polymer within a reasonably thin film but low enough to avoid concentration quenching of the dye's photoluminescent efficiency (typically a few tenths of a percent to few percent). Specifically, the concentration may be in the range of about 0.1 to 3 wt %. The term “a reasonably thin film” depends on parameters such as the in-plane dimensions of the pixel. The film thickness may be small compared to the pixel dimensions to avoid issues with, e.g., parallax. In some cases, it may also be thin enough to permit the formation of electrical vias through it. In most cases, the luminescent layer thickness may be below 10 to15 μm, and even thinner.
In some cases, the copolymer may absorb at all wavelengths below a cutoff wavelength that is fairly close to the copolymer's peak emission wavelength (i.e., the copolymer may have a small Stokes shift and a sharp absorption edge). As used herein, a “small Stokes shift” means a Stokes shift of less than 50 nm.
The copolymer may have a broad absorption, a small Stokes shift, and a high internal emission efficiency. For red emission, the absorption may range from about 200 to 570 nm. For green emission, the absorption may range from about 200 to 520 nm. For blue/UV emission, the absorption may range from about 200 to 450 nm. The internal emission efficiency may be greater than 50% in some examples and greater than 80% in other examples.

In summary, novel water- and/or alcohol-soluble red emissive copolymers for luminescence enhancement in reflective display applications are provided. These types of emissive polymers are copolymers based on substituted fluorene and heterocyclic ring systems that bear water-soluble and/or alcohol-soluble functional groups. These emissive polymers can form a uniform film with commercially-available dyes such as sulforhodamine 640. The synthetic variations available with the copolymer permit tuning the ratio of fluorene and heterocyclic ring unit to thereby adjust the emissive wavelength and quantum efficiency.

Advantages of the polymers disclosed herein may include:
the ability to provide adequate absorption in thinner layers while maintaining emission efficiency (thereby avoiding concentration quenching);
improved robustness, particularly to UV radiation;
easier processing; and
lower cost.

Compositions, devices, and methods described herein may include photoluminescent dyes dispersed in the copolymer matrix that can emit various wavelengths of light. Such matrices may be used in luminescence-based sub-pixels and luminescence-based reflective pixels. It is noted that when discussing the present compositions, devices and methods, each of these discussions can be considered applicable to each of these examples, whether or not they are explicitly discussed in the context of that example.

A luminescence-based sub-pixel may comprise a light shutter with adjustable transmission and a luminescent layer disposed below the light shutter, the luminescent layer including a composite material comprising a luminescent/fluorescent dye and the copolymer. The sub-pixel may also comprise a mirror disposed below the luminescent layer for reflecting light emitted from the dye. The mirror can also be used to reflect light that is not absorbed by the dye, including those wavelengths that are not intended to be absorbed by the dye as well as reflecting wavelengths that are intended to be absorbed during a second pass through the luminescent layer.

Further, a luminescence-based pixel may comprise three luminescent-based sub-pixels, including any of those described herein, wherein each luminescence-based sub-pixel corresponds to a different color of emitted light such that the luminescence-based pixel may emit light over a spectrum of 300 to 800 nm.

Various modifications and combinations may be derived from the present disclosure and illustrations, and as such, the following figures should not be considered limiting.

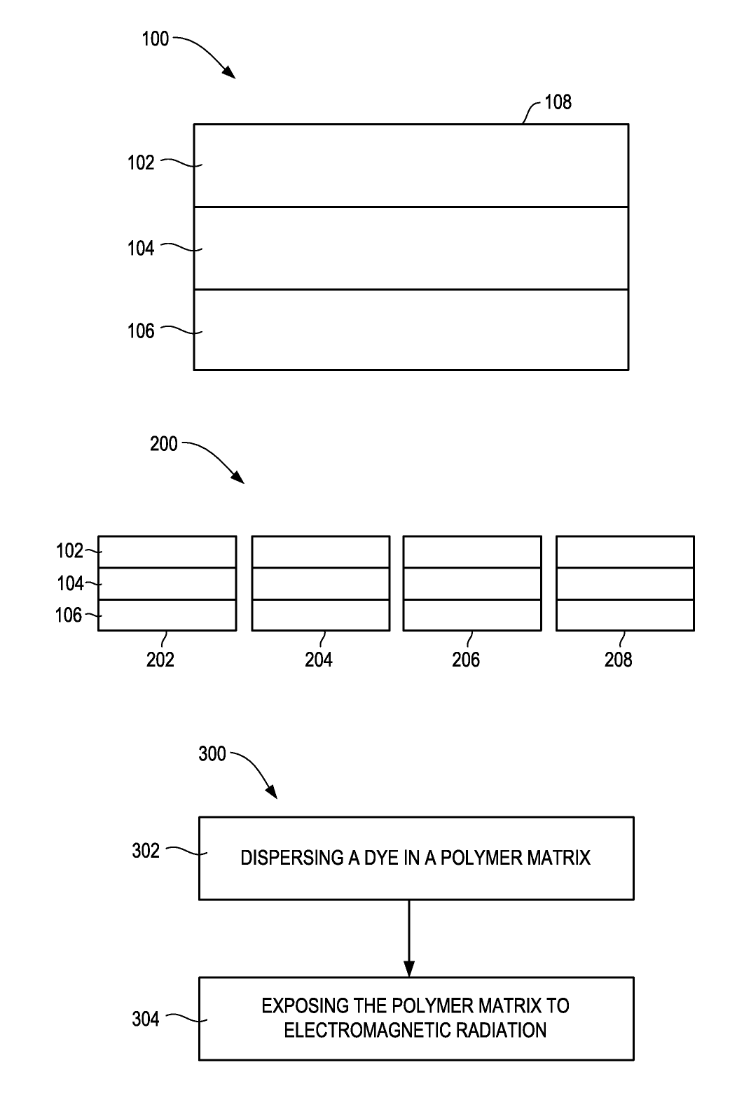

Turning now to FIG. 1, a luminescence-based sub-pixel 100 may comprise a shutter 102, a luminescent layer 104, and a mirror 106. The shutter may form the top layer of the sub-pixel, and ambient light for illumination may enter the sub-pixel through the shutter. The shutter may have a light transmission that is adjustable. The shutter may modulate the intensity of ambient light entering the sub-pixel and also the light leaving the sub-pixel. In this way, the shutter may control the amount of light produced by the sub-pixel to achieve the desired brightness. In some examples, the shutter may comprise an electro-optic shutter, the transparency of which may be modulated from mostly transparent to mostly opaque, over some range of wavelengths and with some number of intermediate gray levels. There are a number of possible choices for the electro-optic shutter, including, but not limited to, black/clear dichroic-liquid crystal (LC) guest-host systems, and in-plane electrophoretic (EP) systems. Other options include cholesteric liquid crystal cells, in-plane electrophoretic devices, or electrowetting layers.

The luminescent layer 104 may include a photoluminescent dye, or luminophore, dispersed in one of the copolymers described above to form a polymer matrix. Additionally, other non-polymer compounds can be present, including additional radiation absorbers, etc. These radiation absorbers can either be UV absorbers included to extend the material's lifetime or color filter materials designed to remove undesirable wavelengths not absorbed by the dyes that transfer energy to the emitters. An example of the latter includes red-absorbing materials incorporated in a green-emitting layer. Incident red wavelengths cannot be (efficiently) converted to green but must be removed in order for the sub-pixel to appear green.

As mentioned above, the radiation absorbers may absorb energy in the form of electromagnetic radiation and transfer the energy to the dye via a resonant energy transfer mechanism. The copolymers disclosed herein comprise radiation absorbers. Additional radiation absorbers may include emissive polymers, dyes, or other radiation-absorbing materials. For example, the additional radiation absorbers may be emissive polymers including, without limitation, poly(9,9′-dioctylfluorene-co-benzothiadiazole); poly[2-methoxy-5-(2′-ethyl-hexyloxy)-1,4-phenylene vinylene]; polyfluorenes; substituted polyfluorenes; polycarbazoles; substituted polycarbazoles; and mixtures thereof.

Further, the luminescent layer 104 may include anti-oxidants or yet additional radiation absorbers, e.g., UV absorbers, used to protect the luminescent dyes from photo-oxidation, thereby making them more robust and photofast. Examples of anti-oxidants may include sterically hindered amines, substituted phenols, and nitro substituted aromatic compounds such as N-methylmorphine, N-methyl morphine oxide, nitrobenzene, 9-nitroanthracene, 2,2′-dinitrobiphenyl, 2,2,6,6-tetramethylpiperidine, N-phenyl-1-naphthalene, and 2,4,6-tertbutylphenol. Examples of UV absorbers may include 2-[2-hydroxy-3,5-di(1,1-dimethylbenzylphenyl)]-2H-benzotriazole, 2-(2′-hydroxy-3′,5′-di-t-butylphenyl)benzotriazole, 2-hydroxy-4-n-octoxybenzophenone, and N—H type polymeric hindered amine light stabilizers, e.g. SONGLIGHT® 9940 (SONGLIGHT is a registered trademark of Songwon Industrial Co., Ltd., Ulson, Korea, for hindered aminic light stabilizers).

These various additional radiation absorbers may be present in the luminescent layer from about 0.01% to about 99.99% by weight. In one example, the radiation absorbers may be present in the luminescent layer from about 0.05% to about 2% by weight.

The luminescent dye may include organic dyes, inorganic phosphors, and/or semiconducting nanocrystals. In one aspect, the luminophore may include, without limitation, BODIPY dyes, perylenes, pyromethenes, rhodamines, sulforhodamines, coumarins, aluminum quinoline complexes, porphyrins, porphins, indocyanine dyes, phenoxazine derivatives, phthalocyanine dyes, polymethyl indolium dyes, polymethine dyes, guaiazulenyl dyes, croconium dyes, polymethine indolium dyes, metal complex IR dyes, cyanine dyes, squarylium dyes, chalcogeno-pyryloarylidene dyes, indolizine dyes, pyrylium dyes, quinoid dyes, quinone dyes, azo dyes, and mixtures and derivatives thereof. Non-limiting examples of specific porphyrin and porphyrin derivatives may include etioporphyrin 1 (CAS 448-71-5), deuteroporphyrin IX 2,4 bis ethylene glycol (D630-9) available from Frontier Scientific, and octaethyl porphrin (CAS 2683-82-1), azo dyes such as Mordant Orange CAS 2243-76-7, Methyl Yellow (60-11-7), 4-phenylazoaniline (CAS 60-09-3), Alcian Yellow (CAS 61968-76-1), available from Aldrich chemical company, and mixtures thereof. In one aspect, the luminophore may include, without limitation, quinoline dyes, porphyrins, porphins, and mixtures and derivatives thereof.

The copolymers disclosed herein are compatible with polar solvents such as water, alcohols (e.g., iso-propanol and iso-hexafluoropropanol), ethyl acetate, dimethylformamide, dimethyl sulfoxide, N-methylpyrrolidone, etc.

Below the luminescent layer 104, the sub-pixel 100 may include a mirror 106 that reflects a selected portion of the optical spectrum. This mirror may be, for example, a Bragg stack, a cholesteric liquid crystal film, an absorbing dye over a broadband mirror, or a layer of optical scatterers such as plasmonic particles. The latter two options may be beneficial in terms of the ease with which mirrors with different reflection bands can be manufactured in a side-by-side sub-pixel configuration (as shown in FIG. 2). The mirror also may be chosen for its reduced dependence on the angle of incidence of the ambient light.

The mirror 106 may be wavelength-selective in that it reflects only light in a selected bandwidth. The reflection bandwidth may be chosen so that the mirror reflects light of the primary color of the sub-pixel but does not reflect other wavelengths. In other cases, the mirror may reflect wavelengths that are absorbed by the luminescent layer as well as wavelengths that contribute to the desired color of the sub-pixel. For example, the mirror for a green sub-pixel may reflect green and blue light but may not reflect any red portion of the incident light. Similarly, the mirror for a blue sub-pixel may reflect blue, and perhaps near UV wavelengths, but not red or green wavelengths. The mirror may enhance the performance of the color sub-pixel in the following three regards.

First, it can re-direct light that is emitted by the dyes away from the viewing surface 108. By reflecting the emitted light back toward the viewing surface, the total amount of light from the sub-pixel available for viewing can be significantly increased. In this regard, with a reasonable Stokes shift (λₑₘᵢₛ-λ_{abs}) separating the absorption edge and the emission wavelength of the luminescent layer, the dye will not significantly re-absorb the reflected emitted light as it passes back through the luminescent layer and out of the viewing surface. Here, λₑₘᵢₛ is the wavelength at which the emission of the lowest energy dye is maximum and λ_{abs} is typically the wavelength at which the absorption of the lowest energy dye is maximum. Any re-absorption that does occur is not a significant problem if the internal emission efficiency of the dyes is high.

Second, the wavelength-selective mirror can enable one to take optimum advantage of the portion of incident ambient light not significantly absorbed by the luminescent layer but with wavelengths that contribute to the creation of the desired color. This portion, which, in general, includes light with wavelengths between λ_{abs} and λₑₘᵢₛ (i.e., within the Stoke shift range) and somewhat beyond λₑₘᵢₛ, will reach the mirror. Some of this light may then be reflected back toward the viewing surface so that it contributes to the overall output of the sub-pixel. Without the mirror, this light is wasted. In some examples, the reflection band of the mirror can be chosen such that it starts at a cut-off wavelength longer than the emission wavelength, and extends to shorter wavelengths that include the absorption edge wavelength λ_{abs} of the luminescent layer. The long-wavelength cut-off of the mirror reflection may be set at the long-wavelength edge of the color band assigned to that sub-pixel. For example, for a red sub-pixel, the reflection band may reach or even go beyond the long-wavelength edge of the standard range of red, as it may be desirable to reflect red out to the limits of human perception. In some examples, a diffusive mirror may be used to randomize the direction of propagation of the emitted light each time it is reflected by the mirror. Diffusive mirrors can be made that scatter the reflected light within a desired characteristic angular range.

The luminescent layers may be configured to emit a specific color of light. The color may be any color including, without limitation, red, blue, green, cyan, yellow, etc.

Turning now to FIG. 2, a luminescence-based pixel 200 may comprise three colored sub-pixels, 202, 204, and 206 in a side-by-side architecture. Each sub-pixel may correspond to a specific color of light. For example, sub-pixel 202 may be a red sub-pixel, sub-pixel 204 may be a green sub-pixel, and sub-pixel 206 may be a blue sub-pixel. Additionally, the luminescence-based pixel may include additional sub-pixels. For example, the luminescence-based pixel may include sub-pixel 208, corresponding to a white color. It is understood that the number of sub-pixels may vary according to the needs of the respective application. In one example, the luminescence-based pixel may be part of a reflective display. Additionally, the luminescence-based pixel comprising three luminescence-based sub-pixels, where each luminescence-based sub-pixel corresponds to a different color of emitted light, may emit light over a spectrum of 300 nm to 800 nm.

Turning now to FIG. 3, a method 300 for illuminating a display may comprise dispersing 302 a dye in a polymer matrix and exposing 304 the polymer matrix to electromagnetic radiation. As previously discussed, the polymer may be any of the copolymers described herein. Additionally, in one example, the method may further comprise tuning the polymer's emission wavelength band to match the absorption band of a photoluminescent dye dispersed within the polymer matrix, as previously discussed. Further, in another example, the method may comprise providing a shutter and a mirror as described herein.

### EXAMPLES

### Example 1

An emissive co-polymer composition is prepared by admixing the emissive co-polymer 1 (R₁, R₂, and R₃ are propyl sulfonate, R₄ through R₁₄ are all hydrogen) and photoluminescent sulforhodamine 640 in poly(methyl acrylate) in toluene, providing approximately 1% of the emissive co-polymer 1 and 1% of sulforhodamine 640 in the polymer by weight. The mixture is then sonicated for one hour. The composition is spin cast, followed by evaporation of the solvent, to form a copolymer-dye composite film.

### Example 2

An emissive co-polymer composition is prepared by admixing the emissive co-polymer 2 (R₁ and R₂ are propyl sulfonate, R₃ through R₉ are all hydrogen) and photoluminescent sulforhodamine 640 in poly(methyl acrylate) in toluene, providing approximately 1% of the emissive co-polymer 2 and 1% of sulforhodamine 640 in the polymer by weight. The mixture is then sonicated for one hour. The composition is spin cast, followed by evaporation of the solvent, to form a copolymer-dye composite film.

### Example 3

An emissive co-polymer composition is prepared by admixing the emissive co-polymer 3 (R₁, R₂, and R₅ are propyl sulfonate, R₃ R₄, and R₆ through R₁₂ are all hydrogen) and photoluminescent sulforhodamine 640 in poly(methyl acrylate) in toluene, providing approximately 1% of the emissive co-polymer 3 and 1% of sulforhodamine 640 in the polymer by weight. The mixture is then sonicated for one hour. The composition is spin cast, followed by evaporation of the solvent, to form a copolymer-dye composite film.

While the disclosure has been described with reference to certain examples, those skilled in the art will appreciate that various modifications, changes, omissions, and substitutions can be made without departing from the spirit of the disclosure.

What is claimed is:

1. Copolymers for luminescent enhancement in reflective display applications, comprising a functionalized fluorene moiety that includes a functional group that is at least one of a water-soluble functional group and an alcohol-soluble functional group and a heterocyclic ring moiety selected from the group consisting of substituted carbazole derivatives, substituted benzothiadiazole derivatives, and substituted phenothiazine derivatives, wherein the respective substituted derivatives include a functional group that is at least one of a water-soluble functional group and an alcohol-soluble functional group.

2. The copolymers of claim 1 wherein the fluorene moiety includes at least two functional groups.

3. The copolymers of claim 1 wherein the alcohol-soluble functional groups are soluble in an alcohol selected from the group consisting of methanol, ethanol, iso-propanol and their perfluorinated analogs.

4. The copolymers of claim 1 wherein the functional groups are selected from the group consisting of COOZ, SO₃Z, PO₃Z, NR⁺Y⁻, and (CH₂CH₂O)ₘCH₃, where Z is independently selected from the group consisting of hydrogen, a monovalent metal ion, and NR₄⁺; R is independently selected from the group consisting of hydrogen, an alkyl group and an aryl group; Y⁻ is an anion selected from the group consisting of a halogen, sulfate, sulfonate, nitrate, phosphate, and borate; and m is an integer ranging from 1 to 500.

5. The copolymers of claim 1 selected from the group consisting of: 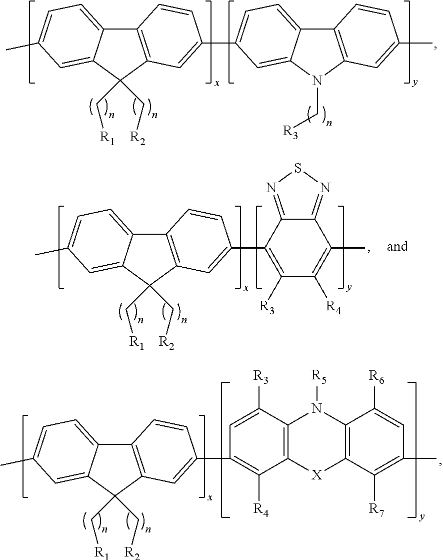
wherein:
the substituents R₁, R₂, R₃, R₄, R₅, R₆, and R₇ are each independently selected from the group consisting of COOZ, SO₃Z, PO₃Z, NR₃⁺Y⁻, and (CH₂CH₂O)ₘCH₃, where Z is independently selected from the group consisting of hydrogen, a monovalent metal ion, and NR₄⁺; R is independently selected from the group consisting of hydrogen, an alkyl group and an aryl group; Y⁻ is selected an anion selected from the group consisting of halogen, sulfate, sulfonate, nitrate, phosphate, and borate; X is oxygen or sulfur; m is an integer ranging from 1 to 500; x and y are integers independently ranging from 1 to 5,000; and n is an integer ranging from 1 to 30.

6. The copolymers of claim 5 selected from the group consisting of: 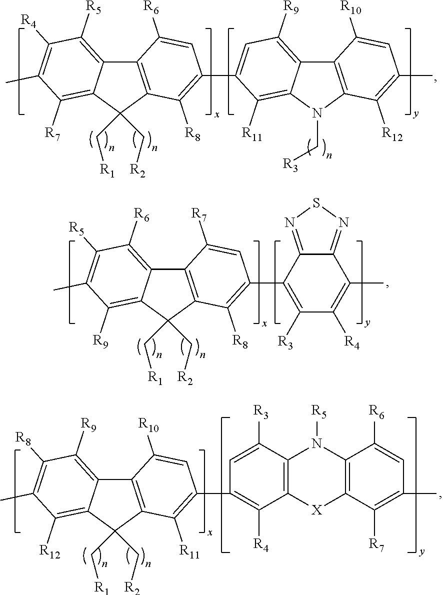
wherein:
additional R substituents are each independently selected from the group consisting of H, COOZ, SO₃Z, PO₃Z, NR₃⁺Y⁻, and (CH₂CH₂O)ₘCH₃.

7. Composite materials comprising a photoluminescent dye and the copolymer of claim 1 for reflective display applications.

8. The composite material of claim 7 further including an additional radiation absorber.

9. The composite material of claim 8 wherein the radiation absorber is an emissive polymer selected from the group consisting of poly(9,9′-dioctylfluorene-co-benzothiadiazole); poly[2-methoxy-5-(2′-ethyl-hexyloxy)-1,4-phenylene vinylene]; polyfluorenes; substituted polyfluorenes; polycarbazoles; substituted polycarbazoles; and mixtures thereof.

10. The composite material of claim 7 further including an anti-oxidant, a UV absorber, or both.

11. The composite material of claim 10 wherein the anti-oxidant is selected from the group consisting of sterically hindered amines, substituted phenols, and nitro substituted aromatic compounds such as N-methylmorphine, N-methyl morphine oxide, nitrobenzene, 9-nitroanthracene, 2,2′-dinitrobiphenyl, 2,2,6,6-tetramethylpiperidine, N-phenyl-1-naphthalene, and 2,4,6-tertbutylphenol.

12. The composite material of claim 10 wherein the UV absorber is selected from the group consisting of 2-[2-hydroxy-3,5-di(1,1-dimethylbenzyl-phenyl)]-2H-benzotriazole, 2-(2′-hydroxy-3′,5′-di-t-butylphenyl) benzotriazole, 2-hydroxy-4-n-octoxybenzophenone, and N—H type polymeric hindered amine light stabilizers.

13. The composite material of claim 7 wherein the photoluminescent dye is selected from the group consisting of organic dyes, inorganic phosphors, and/or semiconducting nanocrystals.

14. The composite material of claim 13 wherein the photoluminescent dye is an organic dye selected from the group consisting of 4,4-difluoro-4-bora-3a,4a-diaza-s-indacene (BODIPY) dyes, perylenes, pyromethenes, rhodamines, sulforhodamines, coumarins, aluminum quinoline complexes, porphyrins, porphins, indocyanine dyes, phenoxazine derivatives, phthalocyanine dyes, polymethyl indolium dyes, polymethine dyes, guaiazulenyl dyes, croconium dyes, polymethine indolium dyes, metal complex IR dyes, cyanine dyes, squarylium dyes, chalcogeno-pyryloarylidene dyes, indolizine dyes, pyrylium dyes, quinoid dyes, quinone dyes, azo dyes, and mixtures and derivatives thereof.

15. A luminescence-based sub-pixel (100), comprising:
a light shutter (102) with adjustable transmission;
a luminescent layer (104) disposed below the light shutter, the luminescent layer containing the composite material of claim 7; and
a mirror (106) disposed below the luminescent layer for reflecting light emitted from the luminescent layer.
